(19) United States
(12) Patent Application Publication
(10) Pub. No.: US 2006/0207809 A1
(43) Pub. Date: Sep. 21, 2006

(54) Electric drive system having cooling strategy

(75) Inventor: Kent A. Casey, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/084,123

(22) Filed: Mar. 21, 2005

(51) Int. Cl. B60K 1/00

(52) U.S. Cl. 180/65.1

(57) ABSTRACT

An electric drive system for a work machine is disclosed. The electric drive system has a first traction device configured to propel the work machine and a first motor drivingly connected to the first traction device. The electric drive system also has a second traction device configured to propel the work machine and a second motor drivingly connected to the second traction device. The electric drive system additionally has a controller in communication with the second motor. The controller is configured to receive an input indicative of a temperature of the first motor and to change a torque output of the second motor in response to the input.

### TECHNICAL FIELD

This disclosure relates generally to an electric drive system and, more particularly, to an electric drive system having a cooling strategy.

### BACKGROUND

Work machines such as, for example, wheel loaders, motor graders, dump trucks, and other types of heavy machinery are used for a variety of tasks. These work machines generally include a power source, which may be, for example, an engine, such as a diesel engine, gasoline engine, or gaseous fuel-powered engine that provides the power required to complete these tasks. To efficiently perform these tasks, the work machines may utilize an electric transmission that is capable of transmitting the torque generated by the engine over a wide range of speeds.

The electric transmission may include, among other things, a generator operably driven by the power source, and one or more motors powered by the generator and drivingly associated with each axle or traction device of the work machine. During typical operation, an amount of torque output from a fore-located motor to a front axle or the axle nearest to an implement of the work machine may be substantially equal to an amount of torque output from an aft-located motor to a rear axle or the axle farthest from the work implement. However, in some situations such as, for example, during loading, while driving into a load pile, or when operating with a poorly distributed load, it may be possible for the torque output of the motors to be disproportionate. In particular, it may be possible for the amount of torque output by the fore-located motor to exceed the amount of torque output from the aft-located motor. Because heat load on a motor is directly related to an amount of torque output from the motor, the fore-located motor outputting the higher amount of torque will have a higher heat load. If the buildup of heat on the fore-located motor is not adequately dissipated, minimized, or prevented, efficiency of the fore-located motor may be reduced and damage of the fore-located motor can occur.

One system for accommodating the heat load associated with increased torque output of a motor is described in U.S. Pat. No. 6,808,470 (the '470 patent) issued to Boll on Oct. 26, 2004. The '470 patent describes a motor vehicle drive having a combustion engine, a generator, a motor, and a clutch disposed between the motor and wheels of the vehicle. During situations in which high torques have to be supplied by the motor, the clutch is operated in a transmitting slipping manner to reduce a torque output of the motor, thereby preventing thermal overloading of the motor.

Although the system of the '470 patent may help minimize thermal overloading of a motor during high torque output situations, it may be expensive and inefficient. In particular, because the system of the '470 patent requires additional clutching components to relieve torque from the thermally overloaded motor, both component and assembly costs of the system may be increased. Further, because the system of the '470 patent reduces thermal loading by wasting power through clutch slippage, efficiency of the work machine employing the system may be reduced.

The electric drive system of the present disclosure is directed towards overcoming one or more of the problems as set forth above.

### SUMMARY OF INVENTION

accordance with one aspect, the present disclosure is directed toward an electric drive system for a work machine. The electric drive system includes a first traction device configured to propel the work machine and a first motor drivingly connected to the first traction device. The electric drive system also includes a second traction device configured to propel the work machine and a second motor drivingly connected to the second traction device. The electric drive system additionally includes a controller in communication with the second motor. The controller is configured to receive an input indicative of a temperature of the first motor and to change a torque output of the second motor in response to the input.

According to another aspect, the present disclosure is directed toward a method of operating an electric drive system having a first motor drivingly associated with a first traction device and a second motor drivingly associated with a second traction device. The method includes monitoring a parameter indicative of a temperature of the first motor and generating a signal corresponding to the temperature. The method also includes changing a torque output of the second motor in response to the signal.

### BRIEF DESCRIPTION OF THE DRAWINGS

FIG. 1 is a pictorial and diagrammatic illustration of an exemplary disclosed work machine; and

FIG. 2 is a pictorial illustration of an exemplary electric drive system for the work machine of FIG. 1.

### DETAILED DESCRIPTION

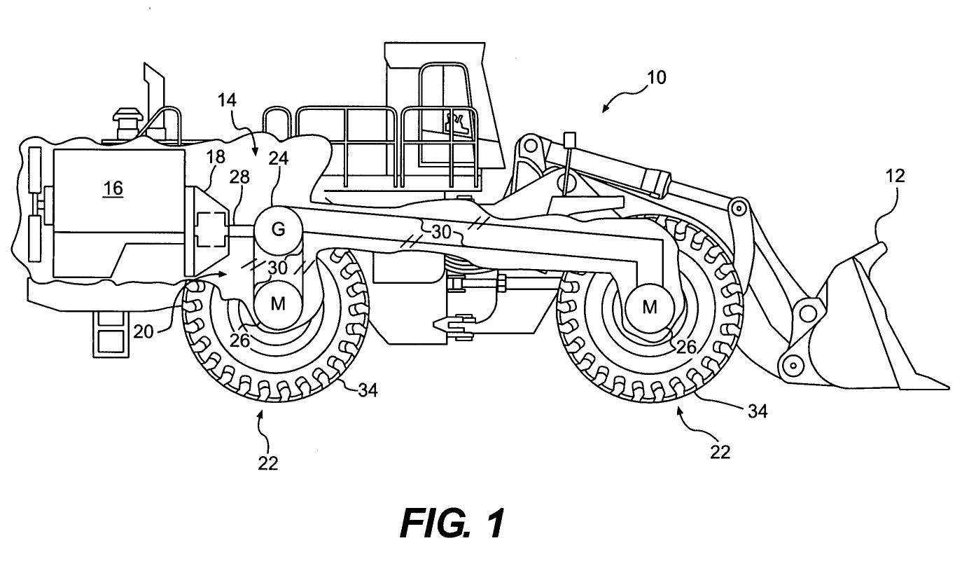

FIG. 1 illustrates an exemplary embodiment of a work machine 10. Work machine 10 may be a mobile machine that performs some type of operation associated with an industry such as mining, construction, farming, transportation, or any other industry known in the art. For example, work machine 10 may be an earth moving machine such as a wheel loader, a dump truck, a backhoe, a motor grader, or any other suitable operation-performing work machine. Work machine 10 may include a work implement 12 and an electric drive system 14.

Work implement 12 may include any device used to perform a particular task. For example, work implement 12 may include a bucket, a fork arrangement, a blade, a shovel, a ripper, a dump bed, a broom, a snow blower, a propelling device, a cutting device, a grasping device, or any other task-performing device known in the art. Work implement 12 may be connected to work machine 10 via a direct pivot, via a linkage system, via one or more hydraulic cylinders, or in any other appropriate manner. Work implement 12 may be configured to pivot, rotate, slide, swing, lift, or move relative to work machine 10 in any manner known in the art.

Electric drive system 14 may include components that interact to propel work machine 10. In particular, electric drive system 14 may include a power source 16, a torque converter 18, and a transmission 20 operably connected to one or more driven traction devices 22. It is contemplated that additional and/or different components may be included within electric drive system 14 such as, for example, additional ratio reducing devices located between transmission 20 and driven traction device 22, one or more storage devices such as a battery or a capacitor, a resistive grid for heat dissipation, a common bus for powering work machine accessories, or any other components known in the art.

Power source 16 may include an internal combustion engine such as, for example, a diesel engine, a gasoline engine, a gaseous fuel-powered engine such as a natural gas engine, or any other engine apparent to one skilled in the art. Power source 16 may alternatively include another source of power such as a furnace, a battery, a fuel cell, a motor connected to an off-board power supply via, for example, an umbilical cord, or any other appropriate source of power. Power source 16 may be configured to produce a power output that is directed to torque converter 18.

Torque converter 18 may be a hydraulic device configured to couple power source 16 to transmission 20. Torque converter 18 may allow power source 16 to rotate somewhat independently of transmission 20. The amount of independent rotation between power source 16 and transmission 20 may be varied by modifying operation of torque converter 18. It is contemplated that torque converter 18 may alternatively embody a non-hydraulic device such as, for example, a mechanical diaphragm clutch. It is further contemplated that torque converter 18 may be omitted, if desired, and transmission 20 connected directly to power source 16.

Transmission 20 may be configured to transmit power from power source 16 to driven traction device 22 at a range of output speed ratios.

Specifically, transmission 20 may include a generator 24 and two or more motors 26. An input drive member such as, for example, a countershaft 28, may connect transmission 20 to torque converter 18. In this manner, power generated by power source 16 may be transmitted by transmission 20 to driven traction device 22. It is contemplated that transmission 20 may alternatively transmit power from power source 16 to driven traction device 22 at only a single output speed ratio.

Various configurations of transmission 20 may be available to drive different driven traction devices 22 or pairs of driven traction devices 22 dependently or independent of each other. Driven traction devices 22 or pairs of driven traction devices 22 may be independently driven by separate motors 26. for example, a separate motor 26 may be associated with and dedicated to each driven traction device 22 or pair of dependently driven traction devices 22 with or without a separate dedicated generator 24.

Generator 24 may embody a three-phase permanent magnet alternating field-type generator configured to produce a power output in response to a rotational input from power source 16. It is also contemplated that generator 24 may be a switched reluctance generator, a direct phase generator, or any other appropriate type of generator known in the art. Generator 24 may be configured to produce electrical power output as a rotor (not shown) is rotated within a stator (not shown) by power source 16. Generator 24 may be connected to each motor 26 by way of one or more power lines 30.

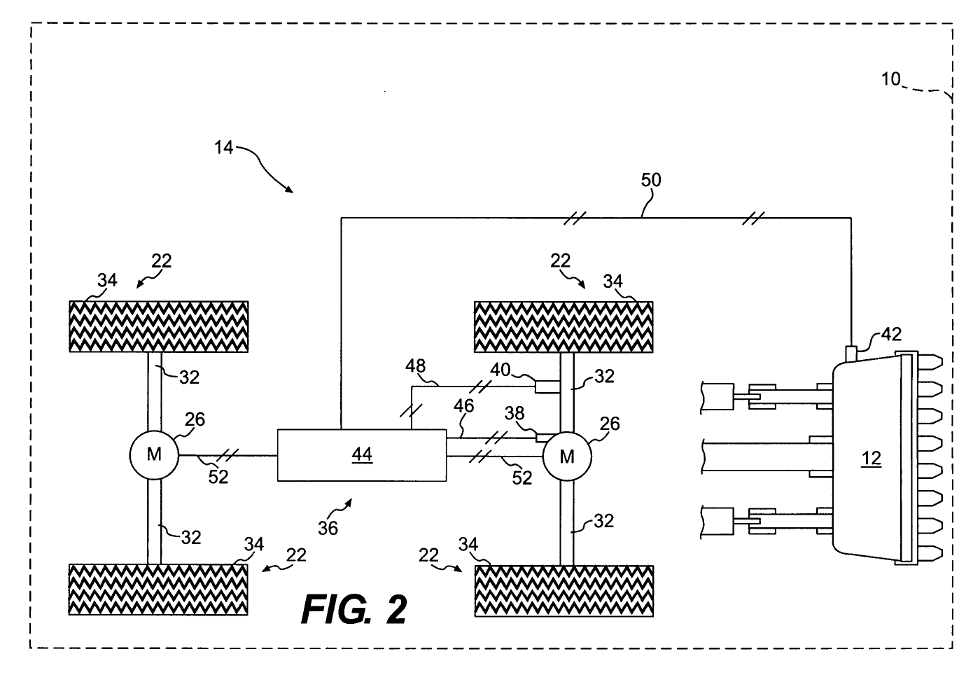

Motor 26 may be a permanent magnet alternating field-type electric motor configured to receive power from generator 24 and to cause movement of driven traction device 22 in response to a torque command. It is also contemplated that motor 26 may be a switched reluctance motor, a direct phase motor, or any other appropriate type of electric motor known in the art. As illustrated in FIG. 2, motor 26 may be connected to driven traction device 22 via a direct shaft coupling 32, via a gear mechanism (not shown), or in any other suitable manner.

Transmission 20 may include power electronics (not shown) to electrically connect generator 24 to motors 26. For example, transmission 20 may include one or more inverters (not shown) configured to invert the three-phase alternating power to direct phase power and vice versa. The drive inverters may have various components including insulated gate bipolar transistors (IGBTs), microprocessors, capacitors, memory storage devices, and any other components that may be used for operating generator 24 and motors 26. Other components that may be associated with the drive inverter include power supply circuitry, signal conditioning circuitry, and solenoid driver circuitry, among others.

Driven traction device 22 may include wheels 34 located on each side of work machine 10. Alternatively, driven traction device 22 may include tracks, belts or other traction devices. Driven traction device 22 may be driven by coupling 32 to rotate in accordance with an output rotation of motor 26. Driven traction device 22 may or may not be steerable.

Electric drive system 14 may further include a control system 36 configured to monitor and affect operation of electric drive system 14. In one example, control system 36 includes a temperature sensor 38 and a torque sensor 40 associated with motor 26 located nearest work implement 12, one or more payload sensors 42, and a controller 44 in communication with each of the sensors of control system 36 and with each motor 26.

Temperature sensor 38 may be configured to sense a temperature of motor 26 that is located nearest work implement 12. Specifically, temperature sensor 38 may embody a wall temperature sensor, an air temperature sensor, or any other type of sensor that may be utilized for monitoring a temperature of motor 26. Temperature sensor 38 may generate a signal indicative of the temperature of motor 26. It is contemplated that control system 36 may additionally include a temperature sensor that is associated with the motor 26 that is located farthest from work implement 12. It is further contemplated that temperature sensor 38 may be omitted if desired.

Torque sensor 40 may be operably associated with coupling 32 and configured to sense a value of torque output from motor 26. It is contemplated that alternative techniques for determining torque output may be implemented such as monitoring various parameters of the work machine 10 and responsively determining a value of output torque from motor 26, or by monitoring a torque command sent to motor 26. For example, engine speed, wheel speed, ground speed, and other parameters may be used, as is well known in the art, to compute output torque from motor 26. Torque sensor 40 may output a signal indicative of the torque output of motor 26.

Payload sensor 42 be configured to sense a load on work implement 12 and/or a distribution of a load on work implement 12. Although only one payload sensor 42 is indicated in FIG. 2, any number of payload sensors 42 may be included as components of a larger payload monitoring system. Each payload sensor 42 may embody, for example, a bucket or bed pressure monitor associated with work implement 12, a strut pressure monitor associated with the suspension of each wheel 34, a hydraulic cylinder and linkage pressure monitor, or any other type of payload sensor known in the art. Each payload sensor 42 may be configured to produce a signal indicative of the load and/or distribution of the load on work implement 12.

Controller 44 may embody a single microprocessor or multiple microprocessors that include a means for controlling an operation of electric drive system 14. Numerous commercially available microprocessors can be configured to perform the functions of controller 44. It should be appreciated that controller 44 could readily embody a general work machine microprocessor capable of controlling numerous work machine functions. Various other known circuits may be associated with controller 44, including power supply circuitry, signal-conditioning circuitry, solenoid driver circuitry, communication circuitry, and other appropriate circuitry.

Controller 44 may be in communication with the components of electric drive system 14. In particular, controller 44 may be in communication with temperature sensor 38 via a communication line 46, with torque sensor 40 via a communication line 48, with payload sensor 42 via a communication line 50, and with motors 26 via communication lines 52. Communication Lines 46-52 may be digital, analog, or mixed types of communication lines. Alternatively, communication with the components of electric drive system 14 may be implemented by means of mechanical or hydraulic connections.

Controller 44 may receive signals from temperature and/or torque sensors 38, 40 to determine a heat load on motor 26. For example, controller 44 may determine that the motor 26 nearest work implement 12 has an increasing heat load by directly monitoring the signal from temperature sensor 38. Alternatively, controller 44 may determine that the motor 26 nearest work implement 12 has an increasing heat load by estimating the temperature of motor 26 from the amount of torque output from motor 26, as measured by torque sensor 40, and a duration of the torque output. It is contemplated that controller 44 may alternatively determine that the motor 26 nearest work implement 12 has an increasing heat load by estimating the temperature of motor 26 from a torque command directed to motor 26 and a duration or accumulation of torque commands without the use of torque sensor 40. The relationship between the temperature of motor 26 and a torque output or command and duration may be determined through testing and stored as an equation, table, or map within the memory of controller 44. The relationship between the temperature of motor 26 and a torque output or command and duration may be periodically calibrated and updated manually or automatically.

Controller 44 may be configured to change a torque output of motor 26 in response to the increasing heat load determination. Specifically, controller 44 may determine that the temperature of the fore-located motor 26 or the motor nearest work implement 12, is above a predetermined temperature, will shortly exceed the predetermined temperature, and/or has remained above the predetermined temperature for a predetermined period of time, and command an increased torque output of the aft-located motor 26, or the motor farthest from work implement 12, in response to the determination. Substantially simultaneously, controller 44 may relieve the torque load on the fore-located motor 26. In one example, after work implement 12 has been unloaded or during situations where the distribution of load between the fore- and aft-located motors 26 would typically approach a substantially equal torque distribution, controller 44 may instead command an increased torque output of the aft-located motor 26 and a decreased torque output of the fore-located motor 26 in anticipation of the next disproportionate heavy torque loading of the fore-located motor 26. By relieving the torque load on the fore-located motor 26 during times of normally substantially equal torque distribution, increased cooling of the fore-located motor 26 may be realized. In this manner, when the fore-located motor 26 is again heavily torque loaded, the fore-located motor 26 may be at a lower temperature than if the fore- and aft-located motors 26 had both been previously equally loaded.

Controller 44 may be configured to load the aft-located motor 26 an amount equal to or less than a current ground tractive capacity during cooling of the fore-located motor 26. For the purposes of this disclosure, the ground tractive capacity is defined as the amount of torque applied to an individual wheel 34, above which slipping of wheel 34 is likely to occur. The ground tractive capacity may be estimated for each wheel 34 based on a loading condition of wheel 34, a coefficient of friction, and the geometry of wheel 34. The loading condition of the wheel 34 may be determined in response to input from payload sensor 42 and a known weight distribution of work machine 10. Provided below is an exemplary equation for estimating the ground tractive capacity.
C_{gt}=Fₙ×μ×r
where:

C_{gt} is the estimated ground tractive capacity;

Fₙ is the force on wheel 34 in the normal direction relative to the engagement surface of wheel 34;

μ is the coefficient of friction; and

r is the radius of wheel 34;

If additional ratio reducing devices are included between transmission 20 and wheel 34, the estimated ground tractive capacity value may be divided by the reduction ratio to determine an amount of torque output from transmission 20 that will result in wheel 34 slipping. In order to minimize the likelihood of wheel 34 slipping, the torque transmitted from transmission 20 to wheel 34 should be limited to less than or equal to the estimated ground tractive capacity.

The coefficient of friction used to estimate the ground tractive capacity may vary depending on the composition of the ground surface and may be updated manually or automatically. Specifically, the coefficient of friction may be indicative of the capacity of the ground to oppose a force transmission from wheel 34. A ground surface having a soft or loose composition may have a lower coefficient of friction when compared to a ground surface having a hard or cohesive composition. The coefficient of friction may be updated manually by a work machine operator to correspond with the current ground composition found at a particular work site or may be automatically updated based on an assumed coefficient of friction and the occurrence of wheel slippage.

### INDUSTRIAL APPLICABILITY

The disclosed electric drive system finds potential application in any mobile machine where it is desirable to cool a motor while maintaining efficiency of the electric drive system. The disclosed electric drive system cools the motor by redistributing a torque load away from the motor during unloaded or well-distributed loaded operations of the work machine. Operation of electric drive system 14 will now be described.

During operation, controller 44 may determine that a torque load on the fore-located motor 26 is causing the fore-located motor 26 to overheat.

This determination may be made by directly monitoring a temperature of the fore-located motor 26 or indirectly by monitoring a torque load on the fore-located motor 26 and a duration of the torque load. The monitored torque load and duration may then be used to estimate a temperature of the fore-located motor by means of the equation, table, or map stored within the memory of controller 44.

When controller 44 determines that the temperature of the fore-located motor has exceeded a predetermined temperature, will soon exceed the predetermined temperature, and/or has remained above a predetermined temperature for a predetermined period of time, controller 44 may act to reduce the torque load on the fore-located motor 26. In particular, controller 44 may command an increased torque output of the rear-located motor 26 to an amount equal to or less than the ground tractive capacity estimated for the rear-located motor 26, while substantially simultaneously reducing the torque load on the fore-located motor 26. This redistributing of torque load away from the fore-located motor may be most effective when work implement 12 is unloaded or when the loading on work machine 10 is equally distributed and the ground tractive capacity is such that increased torque output from the rear-located motor 26 is possible without slipping the rear-located wheels 34. As the temperature of the fore-located motor drops below the predetermined temperature and/or remains below the predetermined temperature for a predetermined period of time, the distribution of torque load between the fore- and aft-located motors 26 may be substantially equalized by reducing the torque output commanded of aft-located motor 26. It is contemplated that controller 44 may alternatively continue the intentional disproportionate loading of the fore- and aft-located motors 26 to maximize cooling of the fore-located motor without reference to a threshold value.

Electric drive system 14 may be cost effective. Specifically, because electric drive system 14 utilizes existing components to improve cooling of the fore-located motor 26, component and assembly costs of work machine 10 may be minimized.

Electric drive system 14 improves the cooling of the fore-located motor 26, while maintaining the efficiency of work machine 10. In particular, because electric drive system 14 cools the fore-located motor 26 by shifting the torque output to the aft-located motor 26, power is transferred rather than wasted. Further, because the torque output of the aft-located motor 26 is only increased to the ground tractive capacity associated with the aft-located driven traction devices 22, little or no slip of wheels 34 occurs, further improving the efficiency of work machine 10.

It will be apparent to those skilled in the art that various modifications and variations can be made to the electric drive system of the present disclosure. Other embodiments of the electric drive system will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. An electric drive system for a work machine, the electric drive system comprising:
a first traction device configured to propel the work machine;
a first motor drivingly connected to the first traction device;
a second traction device configured to propel the work machine;
a second motor drivingly connected to the second traction device; and
a controller in communication with the second motor, the controller configured to receive an input indicative of a temperature of the first motor and to change a torque output of the second motor in response to the input.

2. The electric drive system of claim 1, wherein the sensor is a temperature sensor configured to sense the temperature of the first motor and the controller is configured to increase a torque output of the second motor in response to the temperature of the first motor exceeding a predetermined temperature value.

3. The electric drive system of claim 2, wherein the controller is further configured to determine a current ground tractive capacity associated with the second traction device and increasing the torque output of the second motor includes increasing the torque output of the second motor in a manner not to exceed the determined current ground tractive capacity.

4. The electric drive system of claim 2, wherein the controller is configured to reduce the torque output of the second motor in response to the temperature of the first motor dropping below the predetermined temperature value.

5. The electric drive system of claim 1, wherein the input is at least one of a torque output and a torque command of the first motor and the controller is configured to increase a torque output of the second motor in response to the at least one of a torque command and a torque output of the first motor exceeding a predetermined torque level.

6. The electric drive system of claim 5, wherein the controller is configured to increase a torque output of the second motor in further response to the at least one of a torque output and a torque command of the first motor remaining above the predetermined torque level for a predetermined period of time.

7. The electric drive system of claim 6, wherein the controller is configured to determine a current ground tractive capacity associated with the second traction device and increasing the torque output of the second motor includes increasing the torque output of the second motor in a manner not to exceed the determined current ground tractive capacity.

8. The electric drive system of claim 7, wherein the controller is configured to reduce the torque output of the second motor in response to the at least one of a torque output and a torque command of the first motor dropping below the predetermined torque level.

9. The electric drive system of claim 8, wherein the controller is configured to reduce the torque output of the second motor in further response to the at least one of a torque output and a torque command of the first motor remaining below the predetermined torque level for a predetermined period of time.

10. The electric drive system of claim 1, wherein the controller is further configured to change the torque output of the first motor in response to the input.

11. A method of operating an electric drive system having a first motor drivingly associated with a first traction device and a second motor drivingly associated with a second traction device, the method comprising:
monitoring a parameter indicative of a temperature of the first motor;
generating a signal corresponding to the temperature; and
changing a torque output of the second motor in response to the signal.

12. The method of claim 11, wherein the parameter is a temperature of the first motor and the method further includes increasing a torque output of the second motor in response to the temperature of the first motor exceeding a predetermined temperature value.

13. The method of claim 12, further including determining a current ground tractive capacity associated with the second traction device, wherein increasing the torque output of the second motor includes increasing the torque output of the second motor in a manner not to exceed the determined current ground tractive capacity of the second traction device.

14. The method of claim 12, further including reducing the torque output of the second motor in response to the temperature of the first motor dropping below the predetermined temperature value.

15. The method of claim 11, wherein the parameter is at least one of a torque command and a torque output of the first motor and the method includes increasing a torque output of the second motor in response to the at least one of a torque command and a torque output of the first motor exceeding a predetermined torque level.

16. The method of claim 15, further including increasing a torque output of the second motor in further response to the at least one of a torque command and a torque output of the first motor remaining above predetermined torque level for a predetermined period of time.

17. The method of claim 16, further including determining the current ground tractive capacity of the second traction device, wherein increasing the torque output of the second motor includes increasing the torque output of the second motor in a manner not to exceed the determined current ground tractive capacity of the second traction device.

18. The method of claim 16, further including reducing the torque output of the second motor in response to the at least one of a torque command and a torque output of the first motor dropping below the predetermined torque level.

19. The method of claim 18, further including reducing the torque output of the second motor in further response to the at least one of a torque command and a torque output of the first motor remaining below the predetermined torque level for a predetermined period of time.

20. The method of claim 11, further including changing the torque output of the first motor in response to the signal.

21. A work machine, comprising:
a power source configured to produce a power output;
a first traction device configured to propel the work machine;
a first motor configured to receive the power output and drive the first traction device;
a second traction device configured to propel the work machine;
a second motor configured to receive the power output and drive the second traction device; and
a controller in communication with the second motor, the controller configured to receive an input indicative of a temperature of the first motor and to change a torque output of the first and second motors in response to the input.

22. The work machine of claim 21, wherein the parameter is a temperature of the first motor and the controller is configured to determine a current ground tractive capacity of the second traction device and to increase a torque output of second motor in a manner not to exceed the determined current ground tractive capacity in response to the temperature of the first motor exceeding a predetermined temperature value.

23. The work machine of claim 22, wherein the controller is configured to reduce the torque output of the second motor in response to the temperature of the first motor dropping below the predetermined temperature value.

24. The work machine of claim 21, wherein the parameter is at least one of a torque output and a torque command of the first motor, the controller is configured to determine a current ground tractive capacity of the second traction device and to increase a torque output of the second motor in a manner not to exceed the determined current ground tractive capacity in response to the at least one of a torque output and a torque command of the first motor exceeding a predetermined torque level for a predetermined period of time.

25. The work machine of claim 24, wherein the controller is configured to reduce the torque output of the second motor in response to the at least one of a torque output and a torque command of the first motor dropping below the predetermined torque level and remaining below the predetermined torque level for a predetermined period of time.
